(19) United States
(12) Patent Application Publication
(10) Pub. No.: US 2011/0141072 A1
(43) Pub. Date: Jun. 16, 2011

(54) PLASMA DISPLAY PANEL DRIVING METHOD AND PLASMA DISPLAY DEVICE

(76) Inventors: Hiroyasu Makino, Osaka (JP); Toshikazu Wakabayashi, Osaka (JP); Satoshi Kominami, Osaka (JP); Yasuhiro Arai, Osaka (JP); Masumi Izuchi, Osaka (JP); Junko Matsushita, Osaka (JP)

(21) Appl. No.: 13/058,976

(22) PCT Filed: Jun. 2, 2010
(86) PCT No.: PCT/JP2010/003679

§ 371 Date: Feb. 14, 2011

(30) Foreign Application Priority Data
Jun. 15, 2009 (JP) 2009-142426

(51) Int. Cl. G09G 5/00

(52) U.S. Cl. 345/204; 345/60

(57) ABSTRACT

The present invention provides a plasma display panel driving method and a plasma display device, each of which is capable of securing image quality and realizing an improvement of a drive margin and a reduction in power consumption even in the case of an ultra high definition panel. The present invention divides a plurality of display electrode pairs into a plurality of display electrode pair groups. For each of the display electrode pair groups, the present invention divides one field period into a plurality of sub-fields, each including an address period and a sustain period, such that the address periods with respect to the display electrode pair groups do not overlap one another, the address period being a period in which an address process of causing address discharge in the discharge cell which should emit light is carried out, the sustain period being a period in which first and second sustain pulses are applied to a scan electrode and a sustain electrode. The present invention provides the sub-field in which the cycle of each of the first and second sustain pulses is longer than 5.5 μs within such a range that a time of the sustain period does not exceed Tw×(N−1)/N, where N denotes the number of display electrode pair groups, and Tw denotes a time necessary for carrying out the address process with respect to the discharge cells corresponding to all the display electrode pairs.

### TECHNICAL FIELD

The present invention relates to a plasma display panel driving method and a plasma display device that is a display device using a plasma display panel.

### BACKGROUND ART

Among display devices each using a plasma display panel (hereinafter referred to as a “PDP”), AC surface discharge type plasma display devices are currently typical display devices. In an AC surface discharge type PDP, a front substrate and a back substrate are arranged to be opposed to each other, so that a large number of discharge cells are formed. Hereinafter, the configuration of the AC surface discharge type PDP will be explained.

Configuration of General PDP

A plurality of display electrode pairs, each including a scan electrode and a sustain electrode, are formed on the front substrate to be in parallel with one another. In addition, a dielectric layer and a protective layer are formed on the front substrate so as to cover the display electrode pairs. A plurality of data electrodes are formed on the back substrate so as to be in parallel with one another. In addition, a dielectric layer is formed on the back substrate so as to cover the data electrodes, and a parallel-cross dividing wall is further formed on the dielectric layer. Phosphor layers, each of which emits light of red, green, or blue, are provided in spaces formed by an upper surface of the dielectric layer and side surfaces of the dividing wall.

The front and back substrates formed as above sandwich a minute discharge space and are provided to be opposed to each other such that the display electrode pairs and the data electrodes three-dimensionally cross one another, and outer peripheral portions of the front and back substrates are sealed by a sealing material. The discharge space is filled with a discharge gas. Thus, the discharge cells are formed at portions where the display electrode pairs and the data electrodes intersect with one another. In each discharge cell, ultraviolet is generated by gas discharge, and each phosphor is excited and caused to emit light by the ultraviolet. Thus, color display is performed.

Method for Driving General PDP

Used as a method for driving the PDP is a sub-field method that is a method for dividing one field into a plurality of sub-fields and carrying out gray scale display by combinations of the sub-fields in each of which light is emitted. Each sub-field includes a reset period, an address period, and a sustain period.

In the reset period, a predetermined voltage is applied to the scan electrodes and sustain electrodes of the display electrode pairs to cause reset discharge, and wall charge necessary for a next address operation is generated on each electrode. In the address period, a scan pulse is sequentially applied to the scan electrodes, and an address pulse is selectively applied to the data electrodes of the discharge cells in accordance with a display image to cause address discharge, thereby generating the wall charge on each electrode. In the sustain period, a sustain pulse is alternately applied to the display electrode pairs, each including the scan electrode and the sustain electrode, and sustain discharge is caused in the discharge cell in which the address discharge has been caused, thereby exciting the discharge gas. The ultraviolet generated when the excited discharge gas transits to a stable state excites the phosphor layer of the corresponding discharge cell to generate visible light, thereby performing image display.

Among the sub-field methods, generally used is an Address and Display Separation method (ADS method) in which the address period and the sustain period are completely separated from each other in terms of time. In the ADS method, since the discharge cell in which the address discharge is caused and the discharge cell in which the sustain discharge is caused do not exist at the same time, the PDP can be driven under conditions most appropriate for the address discharge in the address period and conditions most appropriate for the sustain discharge in the sustain period.

Here, the cycle of the sustain pulse in the sustain period is commonly set to 5 to 5.5 μs. However, by lengthening the cycle of the sustain pulse up to about 100 μs, a reduction in power consumption by improvements of a drive margin, light emitting efficiency, and electric power recovery efficiency can be expected.

However, in the ADS method, the sustain period is set in a period other than the address period, so that if the cycle of the sustain pulse is lengthened, the adequate number of sub-fields and adequate number of sustain pulses for securing image quality cannot be secured. For example, in a case where the cycle of the sustain pulse is lengthened from 5 μs that is a common value to 10 μs, the total time exceeds the time of one field as long as the number of sustain pulses is not decreased by half or the number of sub-fields is decreased by one or more.

In order to solve these problems, PTL 1 describes a method for decreasing the number of sustain pulses and lengthening the cycle of the sustain pulse based on image luminance information, such as an average picture level (hereinafter referred to as an “APL”) as images become bright (to be specific, the APL increases).

### CITATION LIST

### Patent Literature

PTL 1: Japanese Laid-Open Patent Application Publication No. 2006-58519

### SUMMARY OF INVENTION

### Technical Problem

However, as described in PTL 1, the cycle of the sustain pulse cannot be lengthened if the APL of the image is not high. If the cycle of the sustain pulse is lengthened although the APL of the image is low, the adequate number of sub-fields and adequate number of sustain pulses for securing the image quality cannot be secured. In the current display industry, an increase in definition of the panel has been pursued, so that a time required for the address period is further lengthening, and a time which can be assigned to the sustain period is shortening even in the case of the image having high APL. Therefore, there is a need for a method for lengthening the cycle of the sustain pulse and realizing the improvement of the drive margin and the reduction in power consumption even in the case of an ultra high definition panel of, for example, 2,160 lines or 4,320 lines.

The present invention was made to solve these problems, and an object of the present invention is to provide a plasma display panel driving method capable of securing the adequate number of sub-fields and adequate luminance for securing the image quality and also capable of realizing the improvement of the drive margin and the reduction in power consumption even in the case of the ultra high definition panel, and a plasma display device using this driving method.

### Solution to Problem

In order to achieve the above object, a plasma display panel driving method of the present invention is a method for driving a plasma display panel in which: a plurality of display electrode pairs and a plurality of data electrodes are arranged to intersect with one another with a gap therebetween, each of the plurality of display electrode pairs including a scan electrode and a sustain electrode; and discharge cells, each including the display electrode pair and data electrode forming the gap, are respectively provided at positions where the plurality of display electrode pairs and the plurality of data electrodes intersect with one another, including the steps of: dividing the plurality of display electrode pairs into a plurality of display electrode pair groups; for each of the display electrode pair groups, dividing one field period into a plurality of sub-fields, each including an address period and a sustain period, such that the address periods with respect to the display electrode pair groups do not overlap one another, the address period being a period in which an address process of causing address discharge in the discharge cell which should emit light is carried out, the sustain period being a period in which sustain discharge is caused in the discharge cell in which the address discharge has been caused, by applying a first sustain pulse to the scan electrode and applying a second sustain pulse having the same cycle as the first sustain pulse to the sustain electrode at a different timing from the first sustain pulse; and providing the sub-field in which the cycle of each of the first sustain pulse and the second sustain pulse is longer than 5.5 μs within such a range that a time of the sustain period does not exceed Tw×(N−1)/N, where N denotes the number of display electrode pair groups, and Tw denotes a time necessary for carrying out the address process with respect to all the discharge cells.

In accordance with this driving method, even in the case of the ultra high definition panel, the adequate number of sub-fields and adequate luminance for securing the image quality can be secured, and the improvement of the drive margin and the reduction in power consumption can be realized.

Moreover, it is desirable that: while one of the display electrode pair groups is in the sustain period, the address process be carried out with respect to the other display electrode pair group; a period of one cycle of each of the first sustain pulse and the second sustain pulse be constituted by a rising period in which each of the first sustain pulse and the second sustain pulse rises from a first potential to a second potential higher than the first potential, a high period in which each of the first sustain pulse and the second sustain pulse maintains the second potential, a falling period in which each of the first sustain pulse and the second sustain pulse falls from the second potential to the first potential, and a low period in which each of the first sustain pulse and the second sustain pulse maintains the first potential; and the first sustain pulse and the second sustain pulse be applied so as not to become the first potential at the same time.

Moreover, as the method for setting the cycle of each of the first sustain pulse and the second sustain pulse to be longer than 5.5 μs, a pulse having the cycle of more than 5.5 μs may be used as each of the first sustain pulse and the second sustain pulse each having the cycle of more than 5.5 μs, the pulse being obtained by extending both a high period and low period of a virtual pulse, the virtual pulse having the cycle of 5.5 μs or shorter and having one cycle period constituted by a rising period in which the virtual pulse rises from a first potential to a second potential higher than the first potential, the high period in which the virtual pulse maintains the second potential, a falling period in which the virtual pulse falls from the second potential to the first potential, and the low period in which the virtual pulse maintains the first potential.

As a method for setting the cycle of each of the first sustain pulse and the second sustain pulse to be longer than 5.5 μs, a pulse having the cycle of more than 5.5 μs may be used as one of the first sustain pulse and the second sustain pulse, the pulse being obtained by extending a high period of a virtual pulse, the virtual pulse having the cycle of 5.5 μs or shorter and having one cycle period constituted by a rising period in which the virtual pulse rises from a first potential to a second potential higher than the first potential, the high period in which the virtual pulse maintains the second potential, a falling period in which the virtual pulse falls from the second potential to the first potential, and a low period in which the virtual pulse maintains the first potential, and a pulse having the cycle of more than 5.5 μs may be used as the other one of the first sustain pulse and the second sustain pulse each having the cycle of more than 5.5 μs, the pulse being obtained by extending the low period of the virtual pulse.

As another method for setting the cycle of each of the first sustain pulse and the second sustain pulse to be longer than 5.5 μs, a pulse having the cycle of more than 5.5 μs may be used as each of the first sustain pulse and the second sustain pulse each having the cycle of more than 5.5 μs, the pulse being obtained by extending a high period of a virtual pulse, the virtual pulse having the cycle of 5.5 μs or shorter and having one cycle period constituted by a rising period in which the virtual pulse rises from a first potential to a second potential higher than the first potential, the high period in which the virtual pulse maintains the second potential, a falling period in which the virtual pulse falls from the second potential to the first potential, and a low period in which the virtual pulse maintains the first potential.

As still another method for setting the cycle of each of the first sustain pulse and the second sustain pulse to be longer than 5.5 μs, a pulse having the cycle of more than 5.5 μs may be used as each of the first sustain pulse and the second sustain pulse each having the cycle of more than 5.5 μs, the pulse being obtained by extending a falling period of a virtual pulse, the virtual pulse having the cycle of 5.5 μs or shorter and having one cycle period constituted by a rising period in which the virtual pulse rises from a first potential to a second potential higher than the first potential, a high period in which the virtual pulse maintains the second potential, the falling period in which the virtual pulse falls from the second potential to the first potential, and a low period in which the virtual pulse maintains the first potential.

As yet another method for setting the cycle of each of the first sustain pulse and the second sustain pulse to be longer than 5.5 μs, a pulse having the cycle of more than 5.5 μs may be used as each of the first sustain pulse and the second sustain pulse each having the cycle of more than 5.5 μs, the pulse being obtained by extending a rising period of a virtual pulse, the virtual pulse having the cycle of 5.5 μs or shorter and having one cycle period constituted by the rising period in which the virtual pulse rises from a first potential to a second potential higher than the first potential, a high period in which the virtual pulse maintains the second potential, a falling period in which the virtual pulse falls from the second potential to the first potential, and a low period in which the virtual pulse maintains the first potential.

Moreover, the cycle of each of the first sustain pulse and the second sustain pulse may be 100 μs or shorter. As above, by lengthening the cycle of the sustain pulse up to about 100 μs, effects, such as the reduction in power consumption by the improvements of the drive margin, light emitting efficiency, and electric power recovery efficiency, can be expected. However, this effect is small even if the cycle of the sustain pulse is lengthened to more than 100 μs.

Moreover, in the sub-field, while preventing a luminance weight of the sub-field from changing, the number of repetitions of each of the first sustain pulse and the second sustain pulse each having the cycle of more than 5.5 μs may be set to be smaller than that of a case where the cycle of each of the first sustain pulse and the second sustain pulse is assumed to be 5.5 μs or shorter.

Moreover, it is desirable that: a reset period in which reset discharge is caused in all the discharge cells at the same time be provided at the beginning of one field period; and after the sustain period in each of the sub-fields, an erase period in which erase discharge is caused in the discharge cell in which discharge has been caused in the sustain period be provided.

Moreover, it is desirable that: while one of the display electrode pair groups is in the sustain period, the address process be carried out with respect to the other display electrode pair group; and the address process be consecutively carried out with respect to any of the display electrode pair groups in one field period other than the reset period and the erase periods.

Moreover, a plasma display device of the present invention is a plasma display device including: a plasma display panel in which a plurality of display electrode pairs and a plurality of data electrodes are arranged to intersect with one another with a gap therebetween, each of the plurality of display electrode pairs including a scan electrode and a sustain electrode, and discharge cells, each including the display electrode pair and data electrode forming the gap, are respectively provided at positions where the plurality of display electrode pairs and the plurality of data electrodes intersect with one another; and a drive circuit configured to drive the plasma display panel, wherein: the drive circuit divides the plurality of display electrode pairs into a plurality of display electrode pair groups; for each of the display electrode pair groups, the drive circuit divides one field period into a plurality of sub-fields, each including an address period and a sustain period, such that the address periods with respect to the display electrode pair groups do not overlap one another, the address period being a period in which an address process of causing address discharge in the discharge cell which should emit light is carried out, the sustain period being a period in which sustain discharge is caused in the discharge cell in which the address discharge has been caused, by applying a first sustain pulse to the scan electrode and applying a second sustain pulse having the same cycle as the first sustain pulse to the sustain electrode at a different timing from the first sustain pulse; and the drive circuit provides the sub-field in which the cycle of each of the first sustain pulse and the second sustain pulse is longer than 5.5 μs within such a range that a time of the sustain period does not exceed Tw×(N−1)/N, where N denotes the number of display electrode pair groups, and Tw denotes a time necessary for carrying out the address process with respect to all the display electrode pairs.

With this configuration, even in the case of the ultra high definition panel, the adequate number of sub-fields and adequate luminance for securing the image quality can be secured, and the improvement of the drive margin and the reduction in power consumption can be realized.

### Advantageous Effects of Invention

The present invention can provide a plasma display panel driving method capable of securing the adequate number of sub-fields and adequate luminance for securing the image quality and realizing the improvement of the drive margin and the reduction in power consumption even in the case of the ultra high definition panel, and a plasma display device using this driving method.

The above object, other objects, features and advantages of the present invention will be made clear by the following detailed explanation of preferred embodiments with reference to the attached drawings.

### BRIEF DESCRIPTION OF DRAWINGS

FIG. 1 is an exploded perspective view showing the configuration of a PDP used in Embodiment 1 of the present invention.

FIG. 2 is a diagram showing the arrangement of electrodes of the PDP used in Embodiment 1 of the present invention.

FIGS. 3(a) to 3(e) are diagrams for explaining a PDP driving method and method for setting the number of display electrode pair groups in Embodiment 1 of the present invention.

FIG. 4 is a diagram showing drive voltage waveforms applied to respective electrodes of the PDP in Embodiment 1 of the present invention.

FIGS. 5(a) and 5(b) are diagrams each showing variations of the drive voltage waveforms applied to respective electrodes in an erase period in an embodiment of the present invention.

FIGS. 6(a) and 6(b) are diagrams each showing one example of the drive voltage waveform of a sustain pulse in Embodiment 1 of the present invention.

FIGS. 7(a) and 7(b) are schematic diagrams each showing one example of a sub-field configuration in which an address operation is not carried out in the erase period in Embodiment 1 of the present invention.

FIG. 8 is a circuit block diagram of a plasma display device in Embodiment 1 of the present invention.

FIG. 9 is a circuit diagram of a scan electrode drive circuit of the plasma display device shown in FIG. 8.

FIG. 10 is a circuit diagram of a sustain electrode drive circuit of the plasma display device shown in FIG. 8.

FIG. 11 is a diagram showing the arrangement of the electrodes of the PDP used in Embodiment 2 of the present invention.

FIG. 12 is a schematic diagram showing the sub-field configuration of the drive voltage waveform in Embodiment 2 of the present invention.

### DESCRIPTION OF EMBODIMENTS

Hereinafter, preferred embodiments of the present invention will be explained in reference to the drawings.

### Embodiment 1

Configuration of PDP (Plasma Display Panel)

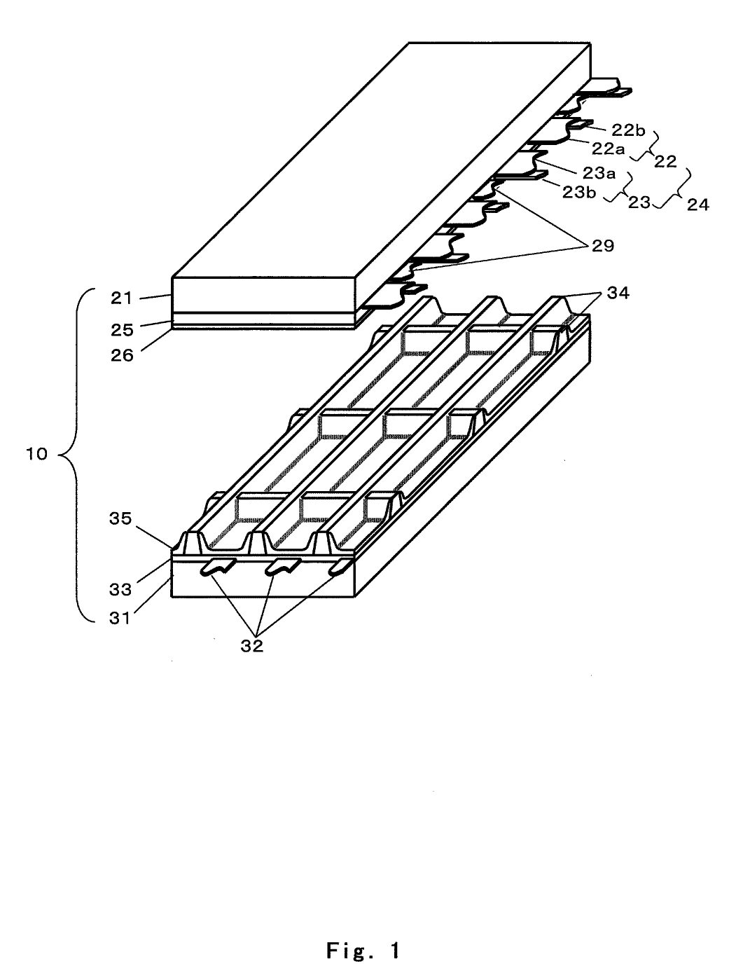

FIG. 1 is an exploded perspective view showing the configuration of a PDP 10 used in Embodiment 1 of the present invention. A plurality of display electrode pairs 24, each including a scan electrode 22 and a sustain electrode 23, are formed on a glass front substrate 21. The scan electrode 22 and the sustain electrode 23 respectively include wide transparent electrodes 22a and 23a in order to obtain light by causing discharge at a discharge gap between the scan electrode 22 and the sustain electrode 23 constituting the display electrode pair 24. Narrow bus electrodes 22b and 23b are respectively stacked on the transparent electrodes 22a and 23a so as to be located far from the discharge gap. A black stripe 29 configured to shield light is provided between the adjacent display electrode pairs 24. A dielectric layer 25 is formed so as to cover the scan electrodes 22, the sustain electrodes 23, and the black stripes 29, and a protective layer 26 is formed on the dielectric layer 25.

A plurality of data electrodes 32 are formed on a back substrate 31, a dielectric layer 33 is formed so as to cover the data electrodes 32, and a parallel-cross dividing wall 34 is further formed on the dielectric layer 33. Phosphor layers 35, each of which emits light of red, green, or blue, are formed on side surfaces of the dividing wall 34 and on the dielectric layer 33.

The front substrate 21 and the back substrate 31 sandwich a minute discharge space and are provided to be opposed to each other such that the display electrode pairs 24 and the data electrodes 32 intersect with one another, and outer peripheral portions of the front and back substrates 21 and 31 are sealed by a sealing material, such as glass frit. In the discharge space, for example, a mixture gas of neon and xenon is filled as a discharge gas. The discharge space is divided into a plurality of spaces by the dividing wall 34, and discharge cells are formed at portions where the display electrode pairs 24 and the data electrodes 32 intersect with one another. These discharge cells discharge and emit light to display images.

The configuration of the PDP 10 is not limited to the above, and for example, a striped dividing wall may be included instead of the parallel-cross dividing wall 34.

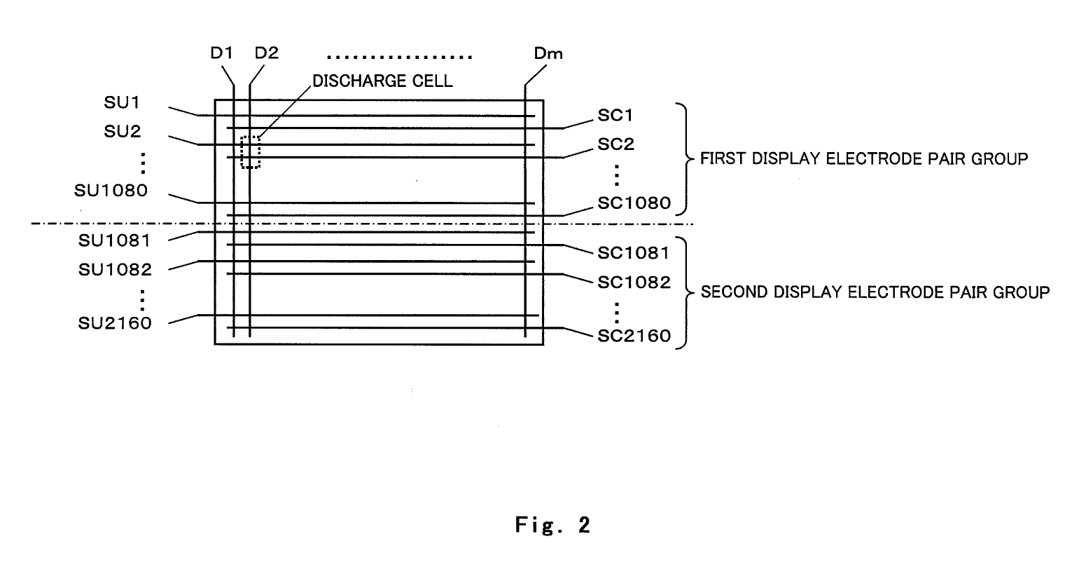

FIG. 2 is a diagram showing the arrangement of the electrodes of the PDP 10 used in Embodiment 1 of the present invention. In the PDP 10, n scan electrodes SC1 to SCn (the scan electrodes 22 of FIG. 1) and n sustain electrodes SU1 to SUn (the sustain electrodes 23 of FIG. 1) are arranged to extend in a row direction (line direction), and m data electrodes D1 to Dm (the data electrodes 32 of FIG. 1) are arranged to extend in a column direction. A region where a pair of electrodes that are the scan electrode SCi (i=1 to n) and the sustain electrode SUi and one data electrode Dj (j=1 to m) sandwich the discharge space and intersect with one another and its adjacent region form one discharge cell which contributes to the image display. Therefore, each discharge cell includes one display electrode pair (the scan electrode SCNi and the sustain electrode SUSi) and one data electrode, and is configured to contain the discharge space between the display electrode pair and the data electrode. In the PDP 10, the discharge cells, the number of which is obtained by m times n, are formed. The number of display electrode pairs is not especially limited. However, the present embodiment explains a case where n is 2,160.

2,160 display electrode pairs that are n scan electrodes SC1 to SC2160 and n sustain electrodes SU1 to SU2160 are divided into a plurality of display electrode pair groups. A method for determining the number N of display electrode pair groups will be described later. The present embodiment will explain, as one example, a case where the display electrode pairs are divided into two display electrode pair groups that are an upper group and lower group of the panel. As shown in FIG. 2, the display electrode pairs located at an upper half of the panel are defined as a first display electrode pair group, and the display electrode pairs located at a lower half of the panel are defined as a second display electrode pair group. To be specific, 1,080 scan electrodes SC1 to SC1080 and 1,080 sustain electrodes SU1 to SU1080 belong to the first display electrode pair group, and 1,080 scan electrodes SC1081 to SC2160 and 1,080 sustain electrodes SU1081 to SU2160 belong to the second display electrode pair group.

Method for Driving PDP

Next, a driving method for driving the PDP 10 will be explained in the present embodiment. Application timings of a scan pulse and address pulse are different between the PDP driving method of the present embodiment and conventional driving methods. In the present embodiment, the scan pulse and the address pulse are applied such that the address operation (address process) is continuously carried out in periods other than a reset period. As a result, a maximum number of sub-fields can be set in one field period. Hereinafter, details of the above will be explained using examples.

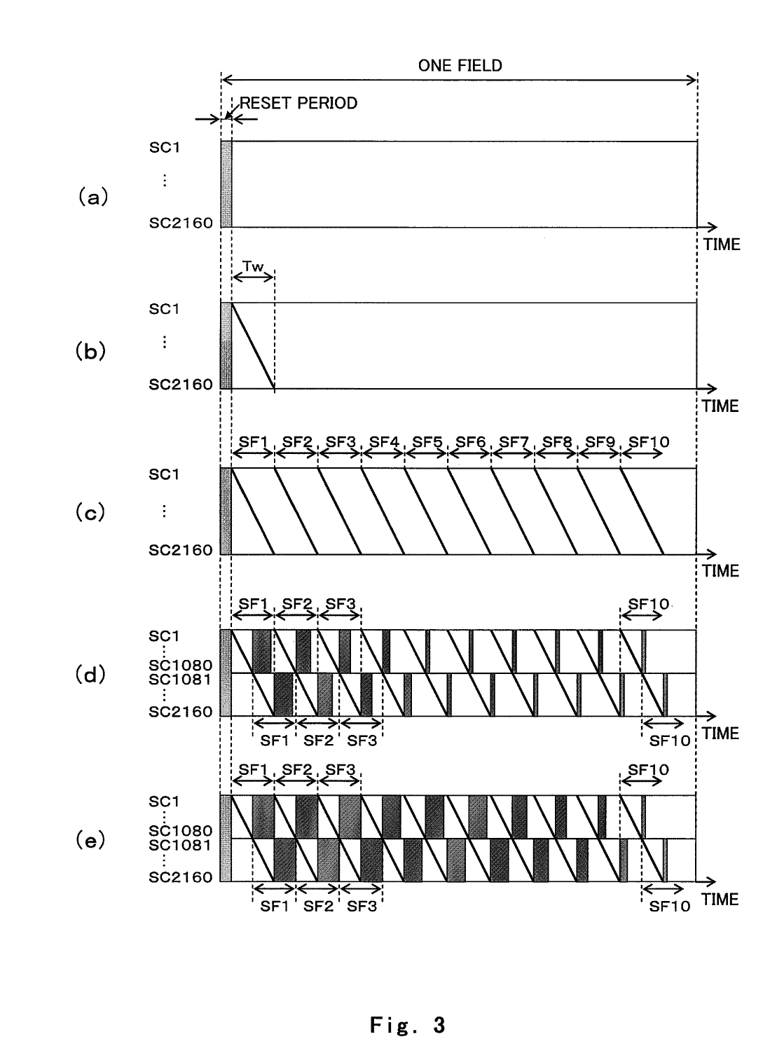

FIG. 3 are diagrams for explaining the PDP driving method and method for setting the number of display electrode pair groups (the number of groups) in Embodiment 1 of the present invention. In FIGS. 3(a) to 3(e), a vertical axis denotes the scan electrodes SC1 to SC2160, and a horizontal axis denotes a time. In addition, a timing for carrying out the address operation is shown by a solid line, and timings for the sustain period and the erase period are shown by hatching. In the following explanation, a time of one field period is 16.7 ms.

First, as shown in FIG. 3(a), the reset period in which reset discharge is caused in all the discharge cells at the same time is provided at the beginning of one field period. In the present embodiment, a time required for the reset period is set to 500 μs (0.5 ms).

Next, as shown in FIG. 3(b), a time Tw required for sequentially applying the scan pulse to the scan electrodes SC1 to SC2160 is estimated. At this time, it is desirable that the scan pulse be applied as short as possible and as consecutively as possible such that the address operation is consecutively carried out. In the present embodiment, a time required for carrying out the address operation with respect to the discharge cells corresponding to one scan electrode (a time necessary for carrying out the address process for one line) is set to 0.7 μs. Since the total number of scan electrodes is 2,160, the time Tw necessary for carrying out the address operation once with respect to the discharge cells corresponding to all the scan electrodes is 1,512 μs (about 1.5 ms (=0.7×2,160)).

Next, the number of sub-fields is estimated. Here, a time required for the erase period is ignored. The time (0.5 ms) of the reset period is subtracted from the time (16.7 ms) of one field period, and the obtained value is divided by the time (1.5 ms) necessary for carrying out the address operation once with respect to all the discharge cells. Thus, 10.8 (=(16.7−0.5)/1.5) is obtained. Therefore, as shown in FIG. 3(c), 10 sub-fields (SF1, SF2, . . . , SF10) can be secured at most. Hereinafter the first, second, . . . , and tenth sub-fields are respectively abbreviated to SF1, SF2, . . . , and SF10.

Next, the number of display electrode pair groups is determined based on the number of necessary sustain pulses. In the present embodiment, the sustain pulses of “120”, “88”, “60”, “36”, “22”, “12”, “6”, “4”, “2”, and “1”, are assumed to be respectively applied in the sub-fields. When the cycle of the sustain pulse is 5 μs, a maximum time Ts required for applying the sustain pulse is 600 μs (=5×120).

The number N of display electrode pair groups is calculated based on the following formula using the time Tw necessary for carrying out the address operation once with respect to all the discharge cells and the maximum time Ts required for applying the sustain pulse.

N≧Tw/(Tw−Ts)

In the present embodiment, since Tw is 1,512 μs, and Ts is 600 μs, 1.66 (=1512/(1512−600)) is obtained, so that the number N of display electrode pair groups is two. Here, even if the number N of display electrode pair groups is three or more, the above formula is satisfied. However, an increase in the number N of display electrode pair groups causes an increase in complexity of a scan electrode drive circuit and sustain electrode drive circuit and an increase in complexity of control of the scan electrode drive circuit and sustain electrode drive circuit. Therefore, in consideration of these demerits, it is preferable that the number N of display electrode pair groups be set to a minimum integer value satisfying the above formula.

Based on the above considerations, the display electrode pairs are divided into two display electrode pair groups as shown in FIG. 2. Then, as shown in FIG. 3(d), the sustain period in which the sustain pulse is applied is provided after the addressing to the scan electrodes belonging to respective groups.

Here, it is clear that the maximum time Ts required for applying the sustain pulse is extremely important to determine the method for driving the PDP 10 and the number of display electrode pair groups. Here, a formula “Ts≦Tw×(N−1)/N” is obtained from the above formula “N≧Tw/(Tw−Ts)”. This indicates that the time of the sustain period in each sub-field of each display electrode pair group cannot exceed Tw×(N−1)/N. In the present embodiment, since N is 2, Tw is 1,512 μs, and Ts is 600 μs, Tw×(N−1)/N=756 600, which satisfies the above formula “Ts≦Tw×(N−1)/N”.

The cycle of the sustain pulse in the sustain period is commonly set to 5 to 5.5 μs. However, by lengthening the cycle of the sustain pulse up to about 100 μs, for example, the reduction in power consumption by the improvements of a drive margin, light emitting efficiency, and electric power recovery efficiency can be expected. Therefore, the cycle of the sustain pulse in each of SF1 to SF9 is lengthened, each of SF1 to SF9 being a sub-field in which the address period and the sustain period are carried out at the same time and whose driving time does not change even if the cycle of the sustain pulse is lengthened (see FIG. 3(e)). Note that the time of the sustain period in each sub-field is set so as not to exceed Tw×(N−1)/N.

For example, the cycle of the sustain pulse can be lengthened by 1.26 times (=756/600) in SF1, 1.72 times (=756/440) in SF2, and 2.52 times (=756/300) in SF3. It is effective to lengthen the cycle of the sustain pulse up to about 100 μs. However, since it is less effective to lengthen the cycle of the sustain pulse to more than 100 μs, the maximum period of the sustain pulse may be about 100 μs.

In the foregoing, the cycle of the sustain pulse is lengthened without changing the number of sustain pulses. However, the luminance of the sustain discharge increases by lengthening the cycle of the sustain pulse, so that the number of sustain pulses may be decreased to prevent luminance weights of respective sub-fields from changing. Moreover, in a case where the number of sustain pulses is decreased to prevent the luminance weights of the sub-fields from changing, signal processing of electric power control can be used without change, and reactive electric power can be reduced by the decrease in the number of sustain pulses.

As above, the driving method for driving the PDP 10 can be determined. In the foregoing explanation, the calculations are carried out while ignoring the time required for the erase period. However, it is desirable that the address operation be not carried out when any of the display electrode pair groups is in the erase period. This is because since the erase period is not only a period in which a wall voltage is erased but also a period in which the wall voltage on the data electrode is adjusted for the address operation of the next address period, it is desirable to fix the potential of the data electrode.

Details of Drive Voltage Waveforms of PDP and Operations Thereof

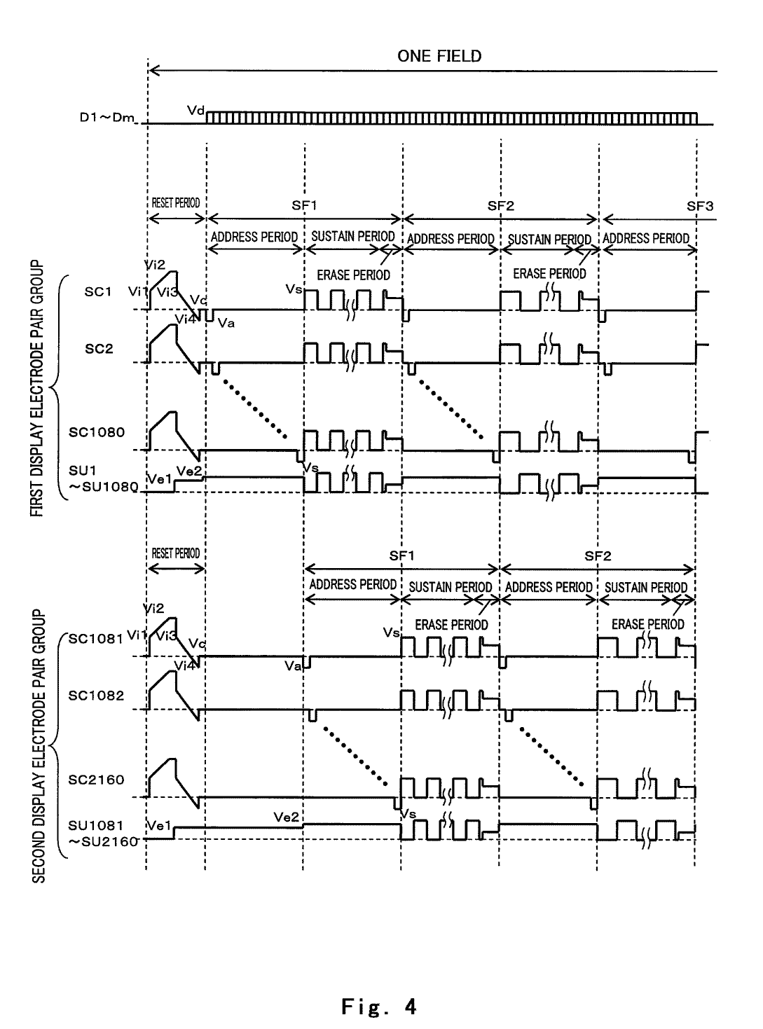

Next, details of the drive voltage waveforms of the PDP 10 and operations thereof will be explained. FIG. 4 is a diagram showing the drive voltage waveforms applied to respective electrodes of the PDP 10 in Embodiment 1 of the present invention. In the present embodiment, the reset period in which the reset discharge is caused in each discharge cell is provided at the beginning of one field, and after the sustain period of each sub-field of each display electrode pair group, the erase period in which erase discharge is caused in the discharge cell in which discharge has been caused in the sustain period is provided. FIG. 4 shows the reset period, SF1, SF2, and the address period of SF3 for the first display electrode pair group and SF1 to SF2 for the second display electrode pair group.

First, the reset period will be explained. The reset period is a period in which the reset discharge is caused to realize a charged state capable of causing the address discharge in each of all the discharge cells.

In the reset period, the potential of 0 (V) is applied to each of the data electrodes D1 to Dm and the sustain electrodes SU1 to SU2160, and a ramp waveform potential is applied to each of the scan electrodes SC1 to SC2160, the ramp waveform potential being a potential moderately rising from a potential Vi1 to a potential Vi2. The potential Vi1 is equal to or lower than a discharge start voltage with respect to the sustain electrodes SU1 to SU2160, and the potential Vi2 exceeds the discharge start voltage. While the ramp waveform potential is rising, weak reset discharge occurs between the scan electrodes SC1 to SC2160 and the sustain electrodes SU1 to SU2160 and between the scan electrodes SC1 to SC2160 and the data electrodes D1 to Dm. Thus, a negative wall voltage is generated on each of the scan electrodes SC1 to SC2160, and a positive wall voltage is generated on each of the data electrodes D1 to Dm and the sustain electrodes SU1 to SU2160. Here, the wall voltage on the electrode is a voltage generated by the wall charge accumulated on the dielectric layer, the protective layer, the phosphor layer, and the like, which cover the electrodes.

Next, a positive potential Ve1 is applied to each of the sustain electrodes SU1 to SU2160, and a ramp waveform potential is applied to each of the scan electrodes SC1 to SC2160. The ramp waveform potential is a potential which moderately falls from a potential Vi3 to a potential Vi4. The potential Vi3 is equal to or lower than the discharge start voltage with respect to the sustain electrodes SU1 to SU2160, and the potential Vi4 exceeds the discharge start voltage. During this time, weak reset discharge occurs between the scan electrodes SC1 to SC2160 and the sustain electrodes SU1 to SU2160 and between the scan electrodes SC1 to SC2160 and the data electrodes D1 to Dm. Thus, the negative wall voltage on each of the scan electrodes SC1 to SC2160 and the positive wall voltage on each of the sustain electrodes SU1 to SU2160 are weakened, and the positive wall voltage on each of the data electrodes D1 to Dm is adjusted to a value appropriate for the address operation. Then, a potential Vc is applied to each of the scan electrodes SC1 to SC2160. Thus, the reset operation is terminated, in which the reset discharge is carried out in all the discharge cells.

Next, the address period of the SF1 for the first display electrode pair group will be explained.

A positive potential Ve2 is applied to each of the sustain electrodes SU1 to SU1080. The scan pulse having a negative potential Va is applied to the scan electrode SC1, and the address pulse having a positive potential Vd is applied to a data electrode Dk (k=1 to m) corresponding to the discharge cell which should emit light. Here, a potential difference at a portion where the data electrode Dk and the scan electrode SC1 intersect with each other is a value obtained by adding the wall voltage on the data electrode Dk and the wall voltage on the scan electrode SC1 to an externally applied voltage (Vd−Va), and this potential difference exceeds the discharge start voltage. Thus, the discharge starts between the data electrode Dk and the scan electrode SC1, and this proceeds to the discharge between the sustain electrode SU1 and the scan electrode SC1, and the address discharge occurs. As a result, the positive wall voltage is generated on the scan electrode SC1, the negative wall voltage is generated on the sustain electrode SU1, and the negative wall voltage is also generated on the data electrode Dk. Thus, the address operation is carried out, in which the address discharge occurs in the discharge cells which should emit light in the first line and the wall voltage is generated on each electrode. In contrast, since a voltage at a portion where each of the data electrodes D1 to Dm to which the address pulse potential Vd is not applied and the scan electrode SC1 intersect with each other does not exceed the discharge start voltage, the address discharge does not occur.

Next, the scan pulse is applied to the scan electrode SC2 of the second line, and the address pulse is applied to the data electrode Dk corresponding to the discharge cell which should emit light. At this time, in the discharge cell of the second line to which the scan pulse and the address pulse are applied at the same time, the address discharge occurs, and the address operation is carried out.

This address operation is repeated until the discharge cell of the 1,080th line, and the address discharge is selectively caused in the discharge cells which should emit light. Thus, the wall charge is generated.

During this time, the second display electrode pair group is in a break period in which the discharge does not occur while the potential Vc is being applied to the scan electrodes SC1081 to SC2060 belonging to the second display electrode pair group, and a potential Ve1 is being applied to the sustain electrodes SU1081 to SU2060 belonging to the second display electrode pair group.

Next, the address period of the SF1 for the second display electrode pair group will be explained.

The positive potential Ve2 is applied to each of the sustain electrodes SU1081 to SU2160. Then, the scan pulse is applied to the scan electrode SC1081, and the address pulse is applied to the data electrode Dk (k=1 to m) corresponding to the discharge cell which should emit light. Thus, the address discharge occurs between the data electrode Dk and the scan electrode SC1081 and between the sustain electrode SU1081 and the scan electrode SC1081. Next, the scan pulse is applied to the scan electrode SC1082, and the address pulse is applied to the data electrode Dk corresponding to the discharge cell which should emit light. Thus, the address discharge occurs in the discharge cell of the 1,082th line to which the scan pulse potential Va and the address pulse potential Vd are applied at the same time.

This address operation is repeated until the discharge cell of the 2,160th line, and the address discharge is selectively caused in the discharge cells which should emit light. Thus, the wall charge is generated.

During this time, the first display electrode pair group is in the sustain period of the SF1. To be specific, the sustain pulse of “120” is alternately applied to the scan electrodes SC1 to SC1080 and sustain electrodes SU1 to SU1080 belonging to the first display electrode pair group. Thus, the discharge cells in which the address discharge has occurred are caused to emit light. Here, the sustain pulse applied to the scan electrodes SC1 to SC1080 and the sustain pulse applied to the sustain electrodes SU1 to SU1080 are the same in cycle as each other but are different in phase from each other by 180°.

Specifically, first, the sustain pulse having a positive potential Vs is applied to each of the scan electrodes SC1 to SC1080, and 0 (V) is applied to each of the sustain electrodes SU1 to SU1080. Here, a potential difference between the scan electrode SCi and the sustain electrode SUi in the discharge cell in which the address discharge has been caused is a value obtained by adding the wall voltage on the scan electrode SCi and the wall voltage on the sustain electrode SUi to the sustain pulse voltage (Vs), and this potential difference exceeds the discharge start voltage. Then, the sustain discharge occurs between the scan electrode SCi and the sustain electrode SUi, and the phosphor layer 35 emits light by the ultraviolet generated at this time. Then, the negative wall voltage is generated on the scan electrode SCi, and the positive wall voltage is generated on the sustain electrode SUi. The sustain discharge does not occur in the discharge cell in which the address discharge has not been caused in the address period, and the wall voltage at the time of the termination of the reset period is maintained.

Next, 0 (V) is applied to each of the scan electrodes SC1 to SC1080, and the sustain pulse having the positive potential Vs is applied to each of the sustain electrodes SU1 to SU1080. Here, the potential difference between the sustain electrode SUi and the scan electrode SCi in the discharge cell in which the sustain discharge has occurred exceeds the discharge start voltage. Therefore, again, the sustain discharge occurs between the sustain electrode SUi and the scan electrode SCi, the negative wall voltage is generated on the sustain electrode SUi, and the positive wall voltage is generated on the scan electrode SCi. Similarly, the sustain pulse is alternately applied to the scan electrodes SC1 to SC1080 and the sustain electrodes SU1 to SU1080, and the potential difference is given between the electrodes of the display electrode pair. With this, the sustain discharge continuously occurs in the discharge cell in which the address discharge has occurred in the address period. Thus, the discharge cell emits light.

The cycle of the sustain pulse in the sustain period is commonly set to 5 to 5.5 μs. However, by lengthening the cycle of the sustain pulse up to about 100 μs, the reduction in power consumption by the improvements of the drive margin, light emitting efficiency, and electric power recovery efficiency can be expected. Therefore, the cycle of the sustain pulse is lengthened in the SF1 on condition that the time of the sustain period does not exceed Tw×(N−1)/N.

In the present embodiment, since N is 2, and Tw is 1,512 μs, Tw×(N−1)/N={1512×(2−1)}/2=756 (μs). Then, in the SF1, the number of sustain pulses is “120”, so that the cycle of the sustain pulse is lengthened to be longer than 5.5 μs within a range not exceeding 6.3 (μs) (=756/120).

The erase period is provided after the sustain period. In the erase period, a so-called narrow pulse potential difference is given to between the scan electrodes SC1 to SCn and the sustain electrodes SU1 to SUn, and this erases the wall charge on the scan electrode SCi and sustain electrode SUi while maintaining the positive wall charge on the data electrode Dk.

Next, the address period of the SF2 for the first display electrode pair group will be explained.

The positive potential Ve2 is applied to each of the sustain electrodes SU1 to SU2160. As with the address period of the SF1, the scan pulse is sequentially applied to the scan electrodes SC1 to SC1080 belonging to the first display electrode pair group, and the address pulse is applied to the data electrode Dk. Thus, the address operation is carried out in the discharge cells of the first to 1,080th lines.

During this time, the second display electrode pair group is in the sustain period of SF1. To be specific, the sustain pulse of “120” is alternately applied to the scan electrodes SC1081 to SC2160 and sustain electrodes SU1081 to SU2160 belonging to the second display electrode pair group. Thus, the discharge cells in which the address discharge has occurred are caused to emit light. Here, the sustain pulse applied to the scan electrodes SC1081 to SC2160 and the sustain pulse applied to the sustain electrodes SU1081 to SU2160 are the same in cycle as each other but is different in phase from each other by 180°.

The sustain pulse of the first display electrode pair group and the sustain pulse of the second display electrode pair group are the same in cycle as each other.

Then, in the erase period after the sustain period, the narrow pulse potential difference is given to between the scan electrodes SC1081 to SC2160 and the sustain electrodes SU1081 to SU2160, and this erases the wall charge on the scan electrode SCi and the sustain electrode SUi while maintaining the positive wall charge on the data electrode Dk.

Similarly, the address period of the SF2 for the second display electrode pair group, the address period of the SF3 for the first display electrode pair group, . . . , and the address period of the SF10 for the second display electrode pair group are provided, and finally, the sustain period and erase period of the SF10 for the second display electrode pair group are provided. Thus, one field terminates.

As above, in the present embodiment, the scan pulse and the address pulse are applied such that the address operation is consecutively carried out in any of the display electrode pair groups after the reset period. As a result, ten sub-fields can be set in one field period. This number of sub-fields is the maximum number of sub-fields which can be set in one field period.

Moreover, in the present embodiment, the sustain period and erase period for the second display electrode pair group are provided at the end, and one field then terminates. Therefore, the driving time can be shortened by providing as the last sub-field the sub-field whose luminance weight is the smallest, which is desirable.

In the present embodiment, the erase operation is carried out by giving the narrow pulse potential difference to between the scan electrode and the sustain electrode in the erase period. The configuration of the sub-field and the number of display electrode pair groups are determined while ignoring the time required for the erase period. Moreover, in the present embodiment, the address operation is carried out even in a case where any of the display electrode pair groups is in the erase period. However, a certain amount of time is necessary to carry out the erase operation, and as described above, it is desirable not to carry out the address operation when any of the display electrode pair groups is in the erase period.

Variations of Drive Voltage Waveform of Erase Period

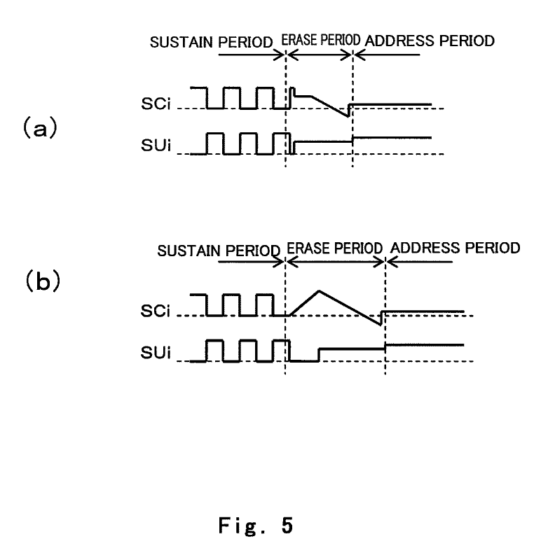

FIGS. 5(a) and 5(b) are diagrams each showing variations (modification examples) of the drive voltage waveforms applied to respective electrodes in the erase period in an embodiment of the present invention. In the case of the drive voltage waveform shown in FIG. 5(a), in the erase period, the narrow pulse potential difference is given to between the scan electrode SCi and the sustain electrode SUi, and the ramp waveform potential moderately falling is then applied to the scan electrode SCi. In accordance with this method, although the time required for the erase period increases, the wall voltage on each electrode can be controlled highly precisely. Moreover, in the case of the drive voltage waveform shown in FIG. 5(b), in the erase period, the ramp waveform potential moderately rising is applied to the scan electrode SCi, and the ramp waveform potential moderately falling is then applied to the scan electrode SCi. In accordance with this method, although the time required for the erase period further increases, the wall voltage on each electrode can be controlled further highly precisely.

Drive Voltage Waveform of Sustain Pulse

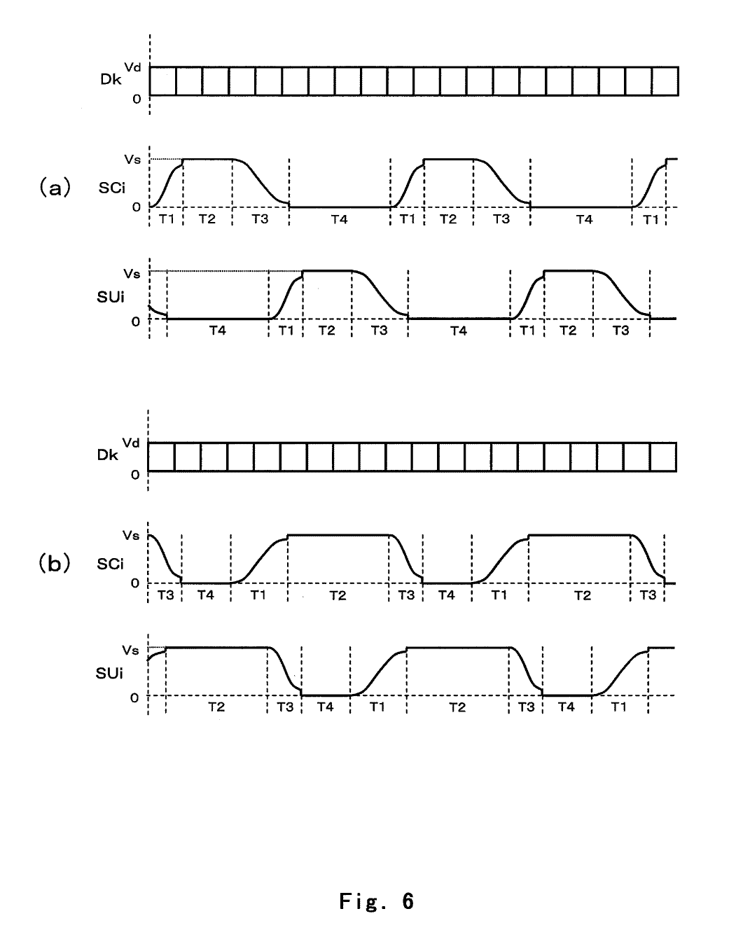

FIGS. 6(a) and 6(b) are diagrams each showing one example of the drive voltage waveform of the sustain pulse applied to each electrode in the sustain period in an embodiment of the present invention. The sustain pulse is constituted by a rising period T1 in which the sustain pulse rises from 0 (V) (first potential) to a potential Vs (second potential), a high period T2 in which the sustain pulse maintains the potential Vs, a falling period T3 in which the sustain pulse falls from the potential Vs to 0 (V), and a low period T4 in which the sustain pulse maintains 0 (V). Then, the sustain pulse of the sustain period which is carried out at the same time as the address period is set such that the scan electrode SCi and the sustain electrode SUi do not become 0 (V) at the same time to prevent the address pulse applied to the data electrode Dk from influencing the sustain pulse. For example, FIG. 6(a) is such a voltage waveform that causes the sustain discharge at the time of the rising of the sustain pulse while preventing the scan electrode SCi and the sustain electrode SUi from becoming 0 (V) at the same time. FIG. 6(b) shows such a voltage waveform that causes the sustain discharge at the time of the falling of the sustain pulse while preventing the scan electrode SCi and the sustain electrode SUi from becoming 0 (V) at the same time.

In an arbitrary sub-field, the cycle of the sustain pulse in the present embodiment is set to be longer than the conventional cycle of the sustain pulse. The conventional cycle is, for example, 5 to 5.5 μs, so that in the present embodiment, the cycle of the sustain pulse is set to be longer than 5.5 μs within such a range that the time of the sustain period does not exceed Tw×(N−1)/N. Here, since the cycle of the sustain pulse is set to be longer within such a range that the time of the sustain period does not exceed Tw×(N−1)/N, the driving time does not change.

In the present embodiment, used as the sustain pulse is a pulse whose cycle is lengthened to be longer than 5.5 μs by extending any of the rising period, the high period, the falling period, and the low period of a virtual pulse having the cycle of 5.5 μs or shorter as with the conventional sustain pulse. Which period is extended will be described below.

There is a method for lengthening the cycle of the sustain pulse in order to lengthen a time for accumulating the wall charge in the sustain pulse. First, this method will be explained.

In order to continue the sustain discharge, it is important to accumulate an adequate amount of wall charge on the scan electrode SCi and the sustain electrode SUi. However, the accumulation of the wall charge requires a finite time, and the adequate amount of wall charge is not accumulated if this time is too short. The time for accumulating the wall charge corresponds to a time in which the high period T2 and the low period T4 overlap each other. To be specific, in each of FIGS. 6(a) and 6(b), each of the time in which the high period T2 of the scan electrode SCi and the low period T4 of the sustain electrode SUi overlap each other and the time in which the low period T4 of the scan electrode SCi and the high period T2 of the sustain electrode SUi corresponds to the time for accumulating the wall charge. The time (time in which the high period T2 and the low period T4 overlap each other) for accumulating the wall charge is lengthened within such a range that the sustain period does not exceed Tw×(N−1)/N. Here, in order to lengthen the time in which the high period T2 and the low period T4 overlap each other, both the high period T2 and low period T4 of the sustain pulse applied to each of the scan electrode SCi and the sustain electrode SUi may be lengthened, or the high period T2 of any one of the sustain pulse applied to the scan electrode SCi and the sustain pulse applied to the sustain electrode SUi may be lengthened and the low period T4 of the other sustain pulse may be lengthened.

The reason why the time for accumulating the wall charge in the sustain pulse is lengthened is as below.

The potential Vs (V) of the sustain pulse alternately applied to the scan electrode SCi and the sustain electrode SUi in the sustain period is set to such a value that causes the sustain discharge in the discharge cell in which the wall charge has been accumulated. However, an output impedance of the drive circuit is not 0 (Ω), and an impedance of the electrode of the panel is not also 0 (Ω), so that if a discharge current flows, the voltage drop caused by these impedances becomes unignorable, and the practical voltage of the sustain pulse applied to each discharge cell decreases. In this case, since the amount of wall charge accumulated on each discharge cell also decreases, the wall voltage runs short, and the sustain discharge cannot be continued. Thus, so-called unlighted cells are generated, and this deteriorates image display quality. Here, in the embodiment of the present invention, by lengthening the time for accumulating the wall charge in the sustain pulse, the practical voltage of the sustain pulse applied to each discharge cell is recovered, and the wall charge is adequately accumulated. Thus, the lack of the wall voltage due to the voltage drop is compensated. Such improvement effect of the drive margin becomes significant as the panel increases in definition and the electrode becomes thin.

As another method for lengthening the cycle of the sustain pulse, there is a method for maintaining the low period T4 and lengthening the high period T2. This method is applicable to such a voltage waveform that causes the sustain discharge at the time of the falling of the sustain pulse as in FIG. 6(b). Although the lack of the wall voltage cannot be compensated by this method, an interval between the sustain discharges can be widened, so that a decrease in efficiency due to phosphor saturation and cumulative ionization can be suppressed, and the improvement of the light emitting efficiency can be expected.

As yet another method for lengthening the cycle of the sustain pulse, there is a method for lengthening the rising period T1 or the falling period T3. The sustain pulse rises and falls by LC resonance of an interelectrode capacity between display electrodes and an electric power collecting inductor. For example, by increasing a value of the electric power collecting inductor to lengthen an LC resonance time (the rising period T1 or the falling period T3), an effective value of a current regarding charging and discharging of the interelectrode capacity between the display electrodes decreases, so that the electric power loss due to the impedance of the drive circuit or the electrode of the panel can be decreased. Therefore, in a case where the sustain discharge occurs at the time of the rising of the sustain pulse as in FIG. 6(a), the falling period T3 which does not contribute to the discharge is lengthened, and in a case where the sustain discharge occurs at the time of the falling of the sustain pulse as in FIG. 6(b), the rising period T1 which does not contribute to the discharge is lengthened. In accordance with the embodiment of the present invention, the sustain period which can be secured is longer than that of the conventional ADS method, so that the rising period T1 or the falling period T3 can be set to be longer than that of the conventional ADS method. Further, if the drive circuit is configured to be able to change the value of the electric power collecting inductor, the electric power loss caused by charging and discharging of the interelectrode capacity between the display electrodes can be adaptively reduced in each sub-field.

Next, the reason why the cycle of the sustain pulse is set to be longer than the conventional cycle (5 to 5.5 μs) will be explained.

As described above, the sustain pulse is constituted by the rising period T1, the high period T2, the falling period T3, and the low period T4. The time for accumulating the wall charge (time in which the high period T2 and the low period T4 overlap each other) is a time necessary for charged particles of the discharge gas generated by the sustain discharge to move and accumulate under the scan electrode SCi and the sustain electrode SUi. The time for accumulating the wall charge commonly requires 1 μs or longer. If the time for accumulating the wall charge is short, the wall charge to be accumulated is small in amount, and the wall voltage runs short. Thus, the sustain discharge cannot be continued, and at the same time, the light emitting efficiency deteriorates. In contrast, the rising period T1 and the falling period T3 are not restricted in terms of time. However, if the rising period T1 and the falling period T3 are short, the electric power recovery efficiency deteriorates, and the power consumption of the plasma display device increases. From the viewpoint of the improvements of the drive margin and light emitting efficiency, the longer each of the high period T2 and the low period T4 is up to about 100 μs, the better. Moreover, from the viewpoint of the improvement of the electric power recovery efficiency, the longer each of the rising period T1 and the falling period T3 is, the better. However, if the times of T1 to T4 are set to be too long, that is, the cycle of the sustain pulse is set to be too long, the adequate number of sub-fields and adequate number of sustain pulses for securing the image quality cannot be secured. Therefore, in consideration of a trade-off relation between the image quality and the power consumption, the cycle of the sustain pulse is set to a minimum required time. For example, in the conventional ADS method, the rising period T1 is 0.5 μs, the high period T2 is 1 μs, the falling period is 1 μs, and the low period is 2.5 μs, so that the total is set to 5 μs.

In accordance with the embodiment of the present invention, the cycle (the times of T1 to T4) of the sustain pulse applied to each of the scan electrode SCi and the sustain electrode SUi is set to be longer than the cycle (5 to 5.5 μs) of the conventional ADS method within such a range that the sustain period of each sub-field does not exceed Tw×(N−1)/N. With this, even in the case of the ultra high definition panel, the adequate number of sub-fields and adequate luminance for securing the image quality can be secured, and the reduction in power consumption by the improvements of the drive margin, light emitting efficiency, and electric power recovery efficiency can be realized.

In the present embodiment, the above effects can be obtained by setting the cycle of the sustain pulse applied to each of the scan electrode SCi and the sustain electrode SUi in any of the sub-fields to be longer than the conventional period (5 to 5.5 μs), without setting the cycle of the sustain pulse applied to each of the scan electrode SCi and the sustain electrode SUi in all the sub-field other than the last sub-field to be longer than the conventional period. For example, in some cases, in the first sub-field whose luminance weight is the largest, the cycle of the sustain pulse applied to each of the scan electrode SCi and the sustain electrode SUi cannot be set to be longer than the conventional period (5 to 5.5 μs) within such a range that the sustain period does not exceed Tw×(N−1)/N. However, in such a case, in each of the second and subsequent sub-fields (except for the last sub-field), the cycle of the sustain pulse applied to each of the scan electrode SCi and the sustain electrode SUi may be set to be longer than the conventional period (5 to 5.5 μs) within such a range that the sustain period does not exceed Tw×(N−1)/N.

In the foregoing, the cycle of the sustain pulse is lengthened without changing the number of sustain pulses. However, since the luminance of the sustain discharge increases by lengthening the cycle of the sustain pulse, the number of sustain pulses may be decreased to prevent the luminance weights of respective sub-fields from changing. Moreover, in a case where the number of sustain pulses is decreased to prevent the luminance weights of the sub-fields from changing, the signal processing of the electric power control can be used without change, and the reactive electric power can be reduced by the decrease in the number of sustain pulses. For example, the luminance increases by 10% if the cycle of the sustain pulse is lengthened from 5 μs to 10 μs. Therefore, the number of sustain pulses can be reduced by 10%, and the reactive electric power can also be reduced by 10%. By measuring the cycle of the sustain pulse and the property of the luminance in detail, the number of sustain pulse can be decreased without changing the luminance weights of respective sub-fields, and the cycle of the sustain pulse can be maximally lengthened within such a range that the sustain period does not exceed Tw×(N−1)/N.

Sub-Field Configuration in which Address Operation is not Carried out in Erase Period

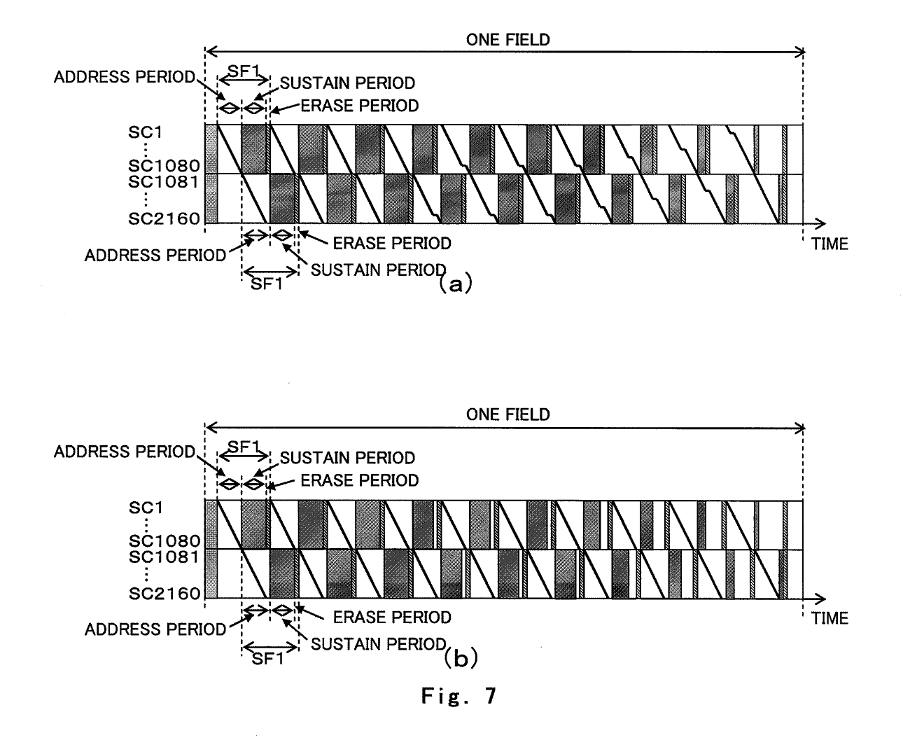

FIGS. 7(a) and 7(b) are schematic diagrams each showing one example of the sub-field configuration in which the address operation is not carried out in the erase period in Embodiment 1 of the present invention. In each of FIGS. 7(a) and 7(b), a vertical axis denotes the scan electrodes SC1 to SC2160, a horizontal axis denotes a time. In addition, a timing for carrying out the address operation is shown by a solid line, and timings for the sustain period and the erase period are shown by different hatching. FIG. 7(a) shows the timings when the erase period is provided immediately after the sustain period. In FIG. 7(a), the address operation of the second display electrode pair group is not carried out when the first display electrode pair group is in the erase period, and the address operation of the first display electrode pair group is not carried out when the second display electrode pair group is in the erase period. FIG. 7(b) shows the timings when provided immediately before the address period is the erase period of the previous sub-field. In FIG. 7(b), the address operation of the second display electrode pair group is not carried out when the first display electrode pair group is in the erase period, and the address operation of the first display electrode pair group is not carried out when the second display electrode pair group is in the erase period.

As above, in a case where the address operation is not carried out when any of the display electrode pair groups is in the erase period, the sub-field configuration and the number of display electrode pair groups need to be determined in consideration of the time required for the erase period. The sustain operation can be carried out even when any of the display electrode pair groups is in the erase period.

Configuration of Plasma Display Apparatus

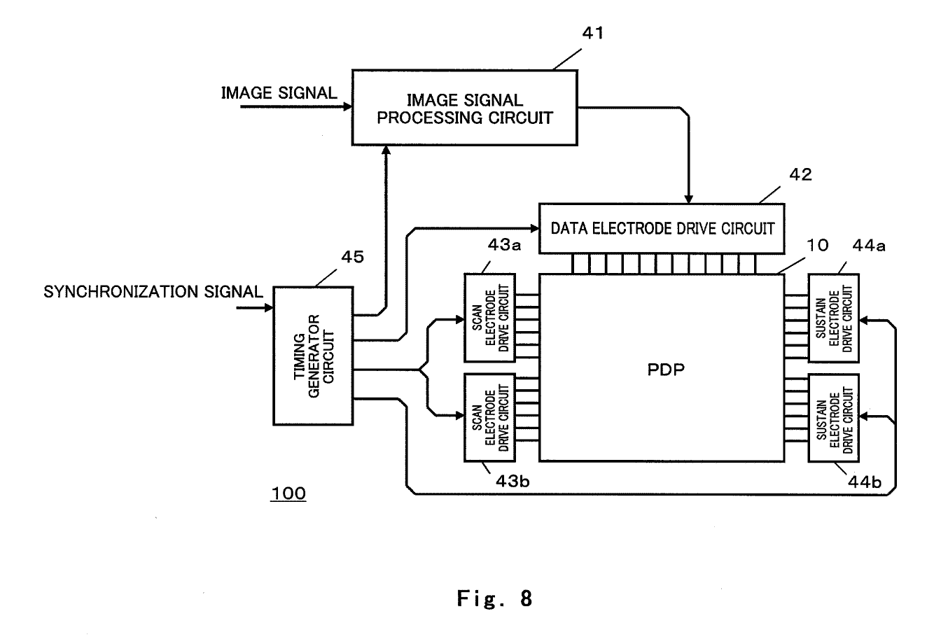

FIG. 8 is a circuit block diagram of a plasma display device 100 in Embodiment 1 of the present invention. The plasma display device 100 includes the PDP 10, an image signal processing circuit 41, a data electrode drive circuit 42, scan electrode drive circuits 43a and 43b, sustain electrode drive circuits 44a and 44b, a timing generator circuit 45, and a power supply circuit (not shown) configured to supply necessary power supply to respective circuit blocks. The plasma display device 100 is configured to carry out, as its operation, the PDP driving method of Embodiment 1.

The image signal processing circuit 41 converts an image signal into image data indicating light emission or light non-emission of each sub-field. The data electrode drive circuit 42 includes m switches configured to apply the address pulse potential Vd or 0 (V) to each of m data electrodes D1 to Dm. The data electrode drive circuit 42 converts the image data output from the image signal processing circuit 41 into a signal corresponding to each of the data electrodes D1 to Dm, and transfers the signal to each of the data electrodes D1 to Dm based on a timing signal from the timing generator circuit 45. Thus, the data electrode drive circuit 42 drives the data electrodes D1 to Dm.

The timing generator circuit 45 generates various timing signals based on horizontal synchronization signals and vertical synchronization signals, the timing signals being signals for controlling operations of respective circuits. The scan electrode drive circuit 43a drives the scan electrodes SC1 to SC1080 belonging to the first display electrode pair group based on the transferred timing signals, and the scan electrode drive circuit 43b drives the scan electrodes SC1081 to SC2160 belonging to the second display electrode pair group based on the transferred timing signals. The sustain electrode drive circuit 44a drives the sustain electrodes SU1 to SU1080 belonging to the first display electrode pair group based on the transferred timing signals, and the sustain electrode drive circuit 44b drives the sustain electrodes SU1081 to SU2160 belonging to the second display electrode pair group based on the transferred timing signals.

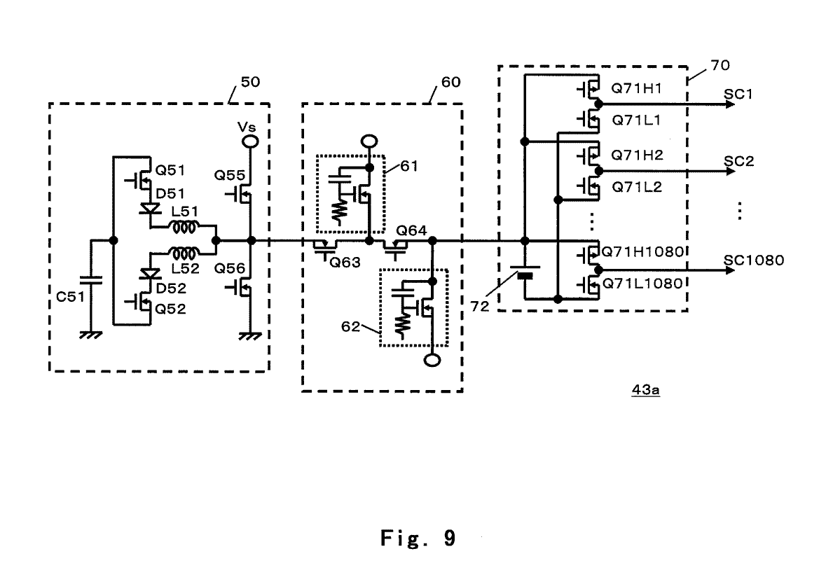

FIG. 9 is a circuit diagram of the scan electrode drive circuit 43a of the plasma display device 100 in Embodiment 1 of the present invention. The scan electrode drive circuit 43a includes a sustain pulse generating circuit 50, a reset waveform generating circuit 60, and a scan pulse generating circuit 70.

The sustain pulse generating circuit 50 includes an electric power collecting capacitor C51, switching elements Q51 and Q52, back flow preventing diodes D51 and D52, electric power collecting inductors L51 and L52, which constitute an electric power collecting portion. The sustain pulse generating circuit 50 further includes switching elements Q55 and Q56, which constitute a voltage clamping portion. The sustain pulse generating circuit 50 applies the sustain pulse to each of the scan electrodes SC1 to SC1080.

In the electric power collecting portion, the LC resonance of the interelectrode capacity (hereinafter referred to as an “interelectrode capacity Cp”) between the display electrodes and the inductor L51 is caused, thereby causing the rising of the sustain pulse, and the LC resonance of the interelectrode capacity Cp between the display electrodes and the inductor L52 is caused, thereby causing the falling of the sustain pulse. At the time of the rising of the sustain pulse, the electric charge accumulated in the electric power collecting capacitor C51 is transferred through the switching element Q51, the diode D51, and the inductor L51 to the interelectrode capacity Cp of the PDP 10. At the time of the falling of the sustain pulse, the electric charge accumulated in the interelectrode capacity Cp is returned through the inductor L52, the diode D52, and the switching element Q52 to the electric power collecting capacitor C51. As above, since the electric power collecting portion drives the display electrode by the LC resonance without the supply of the electric power from the power supply, the power consumption is ideally zero. The electric power collecting capacitor C51 has an adequately larger capacity than the interelectrode capacity Cp and is charged to about half (Vs/2) the voltage Vs so as to serve as the power supply of the electric power collecting portion.

A ½ cycle ta(s) of a rising resonance waveform and a ½ cycle tb(s) of a falling resonance waveform are respectively shown by the following formulas.

ta=π×√(L₅₁×Cp)

tb=π×√(L₅₂×Cp)

In the above formulas, √(L₅₁×Cp) is a positive square root of (L₅₁×Cp), and √(L₅₂×Cp) is a positive square root of (L₅₂×Cp). Moreover, in the above formulas, L₅₁ and L₅₂ respectively denote inductances of the inductors L51 and L52, and ta and tb substantially correspond to the time of the rising period T1 of the sustain pulse and the time of the falling period T3 of the sustain pulse, respectively. Then, in the case of controlling the rising period T1 of the sustain pulse, a plurality of series circuits, each including the switching element Q51, the diode 51, and the inductor L51, are connected to one another in parallel and control the number of times the switching element Q51 is turned on, thereby controlling the value (L₅₁) of the inductor. In contrast, in the case of controlling the falling period T3 of the sustain pulse, a plurality of series circuits, each including the switching element Q52, the diode D52, and the inductor L52, are connected to one another in parallel and control the number of times the switching element Q52 is turned on, thereby controlling the value (L₅₂) of the inductor.

In the voltage clamping portion, the display electrode driven through the switching element Q55 is connected to the power supply and clamped to the potential Vs. Moreover, the display electrode driven through the switching element Q56 is connected to ground and clamped to 0 (V). Therefore, an impedance at the time of voltage application by the voltage clamping portion is low, and high discharge current by strong sustain discharge can flow stably.

As above, the sustain pulse generating circuit 50 controls the switching elements Q51, Q52, Q55, and Q56 to apply the sustain pulse to each of the scan electrodes SC1 to SC1080. Each of these switching elements can be constituted by using a generally known element, such as MOSFET or IGBT.

The reset waveform generating circuit 60 includes a Miller integrator 61 configured to apply the moderately-rising ramp waveform potential to the scan electrodes SC1 to SC1080 in the reset period and a Miller integrator 62 configured to apply the moderately-falling ramp waveform potential to the scan electrodes SC1 to SC1080 in the reset period. Switching elements Q63 and Q64 are separation switches and provided to prevent the current from flowing backward through parasitic diodes of the switching elements constituting the sustain pulse generating circuit 50 and the reset waveform generating circuit 60.

The scan pulse generating circuit 70 includes a DC power supply 72 of a voltage (−Va) for applying the scan potential Va to each of the scan electrodes SC1 to SC1080. The scan pulse generating circuit 70 further includes switching elements Q71H1 and Q71L1 configured to apply the scan potential Va to the scan electrode SC1 according to need, switching elements Q71H2 and Q71L2 configured to apply the scan potential Va to the scan electrode SC2 according to need, . . . , and switching elements Q71H1080 and Q71L1080 configured to apply the scan potential Va to the scan electrode SC1080 according to need. The scan pulse generating circuit 70 sequentially applies the scan potential Va to each of the scan electrodes SC1 to SC1080 at the above-described timing.

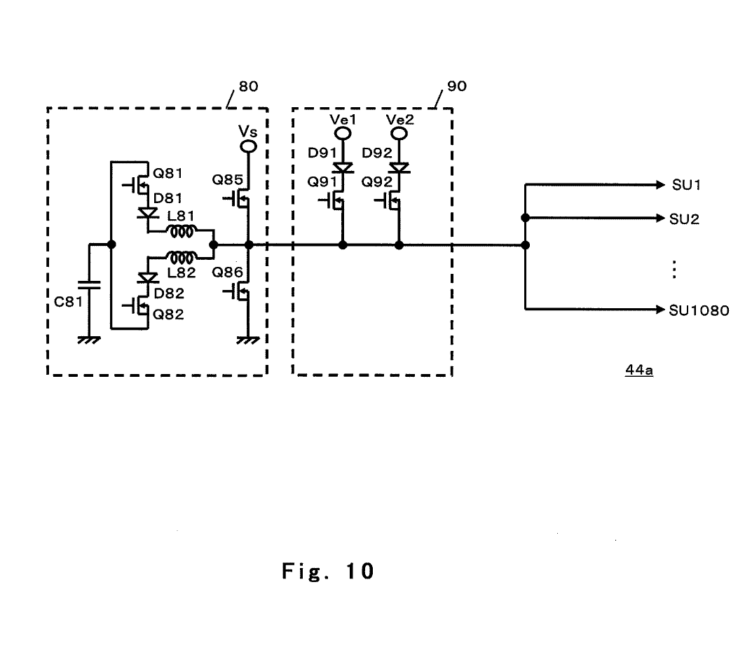

FIG. 10 is a circuit diagram of the sustain electrode drive circuit 44a of the plasma display device 100 in Embodiment 1 of the present invention. The sustain electrode drive circuit 44a includes a sustain pulse generating circuit 80 and a fixed voltage generating circuit 90.

The sustain pulse generating circuit 80 has the same configuration as the sustain pulse generating circuit 50. The sustain pulse generating circuit 80 includes an electric power collecting capacitor C81, switching elements Q81 and Q82, back flow preventing diodes D81 and D82, and resonant inductors L81 and L82, which constitute the electric power collecting portion. The sustain pulse generating circuit 80 further includes switching elements Q85 and Q86, which constitute the voltage clamping portion. The sustain pulse generating circuit 80 applies the sustain pulse to each of the sustain electrodes SU1 to SU1080.

The fixed voltage generating circuit 90 includes a switching element Q91 and a back flow preventing diode D91 and applies the positive potential Ve1 to each of the sustain electrodes SU1 to SU1080 in the reset period. The fixed voltage generating circuit 90 further includes a switching element Q92 and a back flow preventing diode D92 and applies the positive potential Ve2 to each of the sustain electrodes SU1 to SU1080 in the address period.

The scan electrode drive circuit 43b has the same configuration as the scan electrode drive circuit 43a, and the sustain electrode drive circuit 44b has the same configuration as the sustain electrode drive circuit 44a, so that explanations thereof are omitted.

Moreover, the present embodiment has explained a case where the display electrode pairs in the PDP 10 are divided into two display electrode pair groups. However, the present invention is not limited to this. It is desirable that the number of display electrode pair groups be determined based on the maximum number of sustain pulses applied to the display electrode pair in the sustain period. The following will explain, as Embodiment 2, a case where the display electrode pairs are divided into four display electrode pair groups.

### Embodiment 2

As with Embodiment 1, the time of one field period is set to 16.7 ms in Embodiment 2. Moreover, a time required for the reset period is set to 500 μs, and a time required for carrying out the address operation with respect to the discharge cells corresponding to one scan electrode is set to 0.7 μs. In this case, as with Embodiment 1, the time Tw necessary for carrying out the address operation once with respect to the discharge cells corresponding to all the scan electrodes is 1,512 μs, and ten sub-fields can be secured at most.

Next, the number of display electrode pair groups is determined based on the number of necessary sustain pulses. Unlike Embodiment 1, the sustain pulses of “220”, “162”, “110”, “66”, “40”, “22”, “12”, “8”, “4”, and “2” are assumed to be applied in respective sub-fields in Embodiment 2. When the cycle of the sustain pulse is 5 μs, the maximum time Ts required for applying the sustain pulse is 1,100 μs (=5×220).

The number N of display electrode pair groups is calculated based on the following formula using the time Tw necessary for carrying out the address operation once with respect to all the discharge cells and the maximum time Ts required for applying the sustain pulse.

N≧Tw/(Tw−Ts)

In the present embodiment, since Tw is 1,512 μs, and Ts is 1,100 μs, 1512/(1512−1100)=3.67, so that the number N of display electrode pair groups is four.

In this case, Tw×(N−1)/N=1512×3/4=1134, which satisfies the condition “Ts≦Tw×(N−1)/N”.

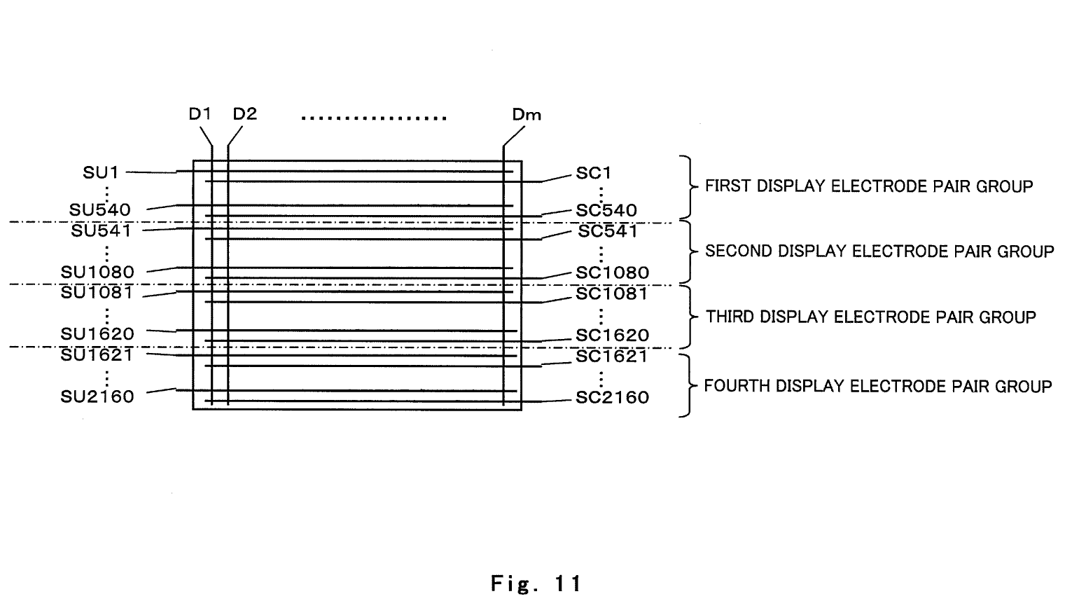

FIG. 11 is a diagram showing the arrangement of the electrodes of the PDP 10 used in Embodiment 2 of the present invention. In the present embodiment, the panel is divided into four parts in the vertical direction, and four display electrode pair groups are defined. Thus, a first display electrode pair group, a second display electrode pair group, a third display electrode pair group, and a fourth display electrode pair group are provided in this order from an upper side of the panel. To be specific, the scan electrodes SC1 to SC540 and the sustain electrodes SU1 to SU540 belong to the first display electrode pair group, the scan electrodes SC541 to SC1080 and the sustain electrodes SU541 to SU1080 belong to the second display electrode pair group, the scan electrode SC1081 to SC1620 and the sustain electrodes SU1081 to SU1620 belong to the third display electrode pair group, and the scan electrodes SC1621 to SC2160 and the sustain electrodes SU1621 to SU2160 belong to the fourth display electrode pair group.

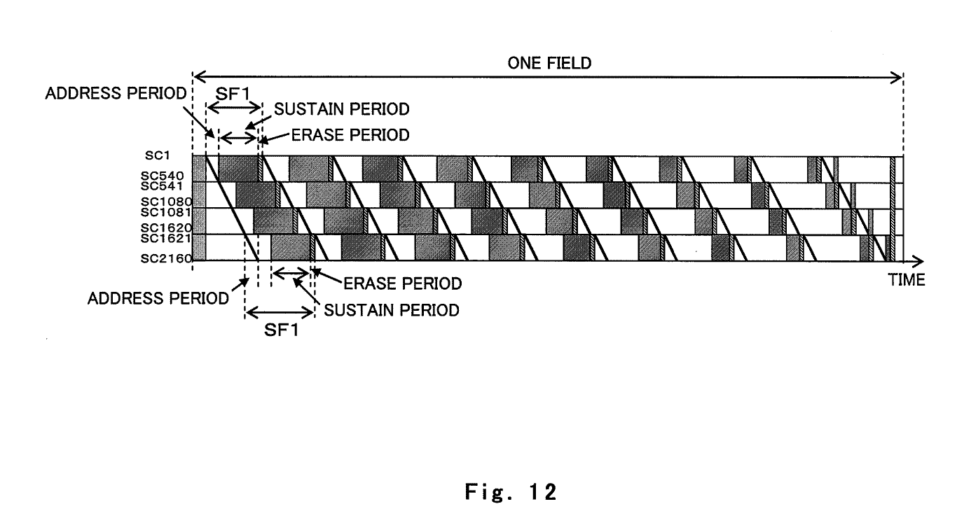

FIG. 12 is a schematic diagram showing the sub-field configuration of the drive voltage waveform in Embodiment 2 of the present invention. In FIG. 12, a vertical axis denotes the scan electrodes SC1 to SC2160, and a horizontal axis denotes a time. In addition, a timing for carrying out the address operation is shown by a solid line, and timings for the sustain period and the erase period are shown by different hatching. As above, by increasing the number of display electrode pair groups, the number of sustain pulses applied to the display electrode pair in the sustain period can be increased, and the cycle of the sustain pulse can be lengthened.

Moreover, in Embodiment 2, the erase period is provided immediately before the address period of the next sub-field. Then, in one field period other than the reset period and the respective erase periods, the address operation is consecutively carried out in any of the display electrode pair groups. In addition, a period in which discharge is not caused is provided between the address period and the sustain period such that the sustain period terminates immediately before the erase period. By providing the erase period immediately after the sustain period as above, the erase discharge can be carried out using priming generated by the sustain discharge, and the erase operation can be stably carried out.

Moreover, the plasma display device configured to execute the PDP driving method of Embodiment 2 as its operation may have the same configuration as the plasma display device 100 of Embodiment 1. For example, as with a case where the plasma display device 100 of Embodiment 1 includes two scan electrode drive circuits 43a and 43b and two sustain electrode drive circuits 44a and 44b, the plasma display device of Embodiment 2 may include four scan electrode drive circuits configured to drive the scan electrodes belonging to the first to fourth display electrode pair groups and four sustain electrode drive circuits configured to drive the sustain electrodes belonging to the first to fourth display electrode pair groups.

In Embodiments 1 and 2, all the display electrode pairs 24 included in the PDP 10 are divided into a plurality of display electrode pair groups. With this, a plurality of discharge cells corresponding to respective display electrode pair groups constitute respective discharge cell groups. To be specific, a plurality of discharge cells including the display electrode pairs belonging to respective display electrode pair groups constitute respective discharge cell groups. Therefore, it is possible to say that: the sub-fields with respect to respective display electrode pair groups are the sub-fields with respect to respective discharge cell groups; in Embodiments 1 and 2, for each of a plurality of discharge cells corresponding to respective display electrode pair groups (for each of the discharge cell groups), one field period is divided into a plurality of sub-fields, each including the address period, the sustain period, and the erase period such that the address periods with respect to the discharge cells (different discharge cell groups) corresponding to different display electrode pair groups do not overlap each other; and in the sustain period with respect to the discharge cells corresponding to one display electrode pair group, the address process with respect to the discharge cells corresponding to the other display electrode pair group is carried out.

Moreover, in Embodiments 1 and 2, the address operation is carried out for each line (for the discharge cells corresponding to one scan electrode, that is, the discharge cells corresponding to the display electrode pair). Therefore, the time Tw necessary for carrying out the address operation once with respect to the discharge cells (discharge cells corresponding to all the display electrode pairs) corresponding to all the scan electrodes is calculated by multiplying the total number of scan electrodes by the time required for carrying out the address operation with respect to the discharge cells (discharge cells corresponding to one display electrode pair) corresponding to one scan electrode. However, Embodiments 1 and 2 are not limited to this. For example, in a case where the address operation is carried out with respect to a plurality of lines at the same time, the time Tw necessary for carrying out the address operation (address process) once with respect to the discharge cells corresponding to all the display electrode pairs may be calculated by multiplying the time required for carrying out the address operation once by the number of times of the address operation necessary for carrying out the address operation with respect to the discharge cells corresponding to all the display electrode pairs. Moreover, the same is true in a case where both the address operation for one line and the address operation for a plurality of lines at the same time are mixed.

Specific numerical values used in Embodiments 1 and 2 are just examples, and it is desirable that these values be suitably set to most appropriate values in accordance with the property of the panel (PDP), the spec of the plasma display device, and the like.

From the foregoing explanation, many modifications and other embodiments of the present invention are obvious to one skilled in the art. Therefore, the foregoing explanation should be interpreted only as an example and is provided for the purpose of teaching the best mode for carrying out the present invention to one skilled in the art. The structures and/or functional details may be substantially modified within the spirit of the present invention.

### INDUSTRIAL APPLICABILITY

The present invention is useful as, for example, a plasma display panel driving method capable of securing the adequate number of sub-fields and adequate luminance for securing the image quality and realizing the improvement of the drive margin and the reduction in power consumption even in the case of the ultra high definition panel of 2,160 lines or more, and a plasma display device using this driving method.

### REFERENCE SIGNS LIST

10 plasma display panel

22 scan electrode

23 sustain electrode

24 display electrode pair

32 data electrode

41 image signal processing circuit

42 data electrode drive circuit

43a, 43b scan electrode drive circuit

44a, 44b sustain electrode drive circuit

43 display electrode pair drive circuit

45 timing generator circuit

100 plasma display device

1. A method for driving a plasma display panel in which: a plurality of display electrode pairs and a plurality of data electrodes are arranged to intersect with one another with a gap therebetween, each of the plurality of display electrode pairs including a scan electrode and a sustain electrode; and discharge cells, each including the display electrode pair and data electrode forming the gap, are respectively provided at positions where the plurality of display electrode pairs and the plurality of data electrodes intersect with one another, comprising the steps of:
dividing the plurality of display electrode pairs into a plurality of display electrode pair groups;
for each of the display electrode pair groups, dividing one field period into a plurality of sub-fields, each including an address period and a sustain period, such that the address periods with respect to the display electrode pair groups do not overlap one another, the address period being a period in which an address process of causing address discharge in the discharge cell which should emit light is carried out, the sustain period being a period in which sustain discharge is caused in the discharge cell in which the address discharge has been caused, by applying a first sustain pulse to the scan electrode and applying a second sustain pulse having the same cycle as the first sustain pulse to the sustain electrode at a different timing from the first sustain pulse; and
providing the sub-field in which the cycle of each of the first sustain pulse and the second sustain pulse is longer than 5.5 μs within such a range that a time of the sustain period does not exceed Tw×(N−1)/N, where N denotes the number of display electrode pair groups, and Tw denotes a time necessary for carrying out the address process with respect to all the discharge cells,
wherein while preventing a luminance weight of the sub-field from changing, the number of first sustain pulses each having the cycle of longer than 5.5 μs and the number of second sustain pulses each having the cycle of longer than 5.5 μs are decreased to be respectively smaller than the number of first sustain pulses each having the cycle which is assumed to be 5.5 μs or shorter and the number of second sustain pulses each having the cycle which is assumed to be 5.5 μs or shorter.

2. The method according to claim 1, wherein: while one of the display electrode pair groups is in the sustain period, the address process is carried out with respect to the other display electrode pair group; a period of one cycle of each of the first sustain pulse and the second sustain pulse is constituted by a rising period in which each of the first sustain pulse and the second sustain pulse rises from a first potential to a second potential higher than the first potential, a high period in which each of the first sustain pulse and the second sustain pulse maintains the second potential, a falling period in which each of the first sustain pulse and the second sustain pulse falls from the second potential to the first potential, and a low period in which each of the first sustain pulse and the second sustain pulse maintains the first potential; and the first sustain pulse and the second sustain pulse are applied so as not to become the first potential at the same time.

3. The method according to claim 1, wherein a pulse having the cycle of more than 5.5 μs is used as each of the first sustain pulse and the second sustain pulse each having the cycle of more than 5.5 μs, the pulse being obtained by extending both a high period and low period of a virtual pulse, the virtual pulse having the cycle of 5.5 μs or shorter and having one cycle period constituted by a rising period in which the virtual pulse rises from a first potential to a second potential higher than the first potential, the high period in which the virtual pulse maintains the second potential, a falling period in which the virtual pulse falls from the second potential to the first potential, and the low period in which the virtual pulse maintains the first potential.

4. The method according to claim 1, wherein: a pulse having the cycle of more than 5.5 μs is used as one of the first sustain pulse and the second sustain pulse, the pulse being obtained by extending a high period of a virtual pulse, the virtual pulse having the cycle of 5.5 μs or shorter and having one cycle period constituted by a rising period in which the virtual pulse rises from a first potential to a second potential higher than the first potential, the high period in which the virtual pulse maintains the second potential, a falling period in which the virtual pulse fails from the second potential to the first potential, and a low period in which the virtual pulse maintains the first potential; and a pulse having the cycle of more than 5.5 μs is used as the other one of the first sustain pulse and the second sustain pulse each having the cycle of more than 5.5 μs, the pulse being obtained by extending the low period of the virtual pulse.

5. The method according to claim 1, wherein a pulse having the cycle of more than 5.5 μs is used as each of the first sustain pulse and the second sustain pulse each having the cycle of more than 5.5 μs, the pulse being obtained by extending a high period of a virtual pulse, the virtual pulse having the cycle of 5.5 μs or shorter and having one cycle period constituted by a rising period in which the virtual pulse rises from a first potential to a second potential higher than the first potential, the high period in which the virtual pulse maintains the second potential, a falling period in which the virtual pulse falls from the second potential to the first potential, and a low period in which the virtual pulse maintains the first potential.

6. The method according to claim 1, wherein a pulse having the cycle of more than 5.5 μs is used as each of the first sustain pulse and the second sustain pulse each having the cycle of more than 5.5 μs, the pulse being obtained by extending a falling period of a virtual pulse, the virtual pulse having the cycle of 5.5 μs or shorter and having one cycle period constituted by a rising period in which the virtual pulse rises from a first potential to a second potential higher than the first potential, a high period in which the virtual pulse maintains the second potential, the falling period in which the virtual pulse falls from the second potential to the first potential, and a low period in which the virtual pulse maintains the first potential.

7. The method according to claim 1, wherein a pulse having the cycle of more than 5.5 μs is used as each of the first sustain pulse and the second sustain pulse each having the cycle of more than 5.5 μs, the pulse being obtained by extending a rising period of a virtual pulse, the virtual pulse having the cycle of 5.5 μs or shorter and having one cycle period constituted by the rising period in which the virtual pulse rises from a first potential to a second potential higher than the first potential, a high period in which the virtual pulse maintains the second potential, a falling period in which the virtual pulse falls from the second potential to the first potential, and a low period in which the virtual pulse maintains the first potential.

8. The method according to claim 1, wherein the cycle of each of the first sustain pulse and the second sustain pulse is 100 μs or shorter.

9. (canceled)

10. The method according to claim 1, wherein: a reset period in which reset discharge is caused in all the discharge cells at the same time is provided at the beginning of one field period; and after the sustain period in each of the sub-fields, an erase period in which erase discharge is caused in the discharge cell in which discharge has been caused in the sustain period is provided.

11. The method according to claim 10, wherein: while one of the display electrode pair groups is in the sustain period, the address process is carried out with respect to the other display electrode pair group; and the address process is consecutively carried out with respect to any of the display electrode pair groups in one field period other than the reset period and the erase periods.

12. A plasma display device comprising:
a plasma display panel in which a plurality of display electrode pairs and a plurality of data electrodes are arranged to intersect with one another with a gap therebetween, each of the plurality of display electrode pairs including a scan electrode and a sustain electrode, and discharge cells, each including the display electrode pair and data electrode forming the gap, are respectively provided at positions where the plurality of display electrode pairs and the plurality of data electrodes intersect with one another; and
a drive circuit configured to drive the plasma display panel, wherein:
the drive circuit divides the plurality of display electrode pairs into a plurality of display electrode pair groups;
for each of the display electrode pair groups, the drive circuit divides one field period into a plurality of sub-fields, each including an address period and a sustain period, such that the address periods with respect to the display electrode pair groups do not overlap one another, the address period being a period in which an address process of causing address discharge in the discharge cell which should emit light is carried out, the sustain period being a period in which sustain discharge is caused in the discharge cell in which the address discharge has been caused, by applying a first sustain pulse to the scan electrode and applying a second sustain pulse having the same cycle as the first sustain pulse to the sustain electrode at a different timing from the first sustain pulse; and
the drive circuit provides the sub-field in which the cycle of each of the first sustain pulse and the second sustain pulse is longer than 5.5 μs within such a range that a time of the sustain period does not exceed Tw×(N−1)/N, where N denotes the number of display electrode pair groups, and Tw denotes a time necessary for carrying out the address process with respect to all the discharge cells,
wherein while preventing a luminance weight of the sub-field from changing, the number of first sustain pulses each having the cycle of longer than 5.5 μs and the number of second sustain pulses each having the cycle of longer than 5.5 μs are decreased to be respectively smaller than the number of first sustain pulses each having the cycle which is assumed to be 5.5 μs or shorter and the number of second sustain pulses each having the cycle which is assumed to be 5.5 μs or shorter.
